(19) United States
(12) Patent Application Publication
(10) Pub. No.: US 2009/0074582 A1
(43) Pub. Date: Mar. 19, 2009

(54) METHOD FOR JOINING METAL COMPONENTS AND DEVICE FOR EXECUTION OF AN INDUCTIVE LOW OR HIGH-FREQUENCY PRESSURE WELDING METHOD

(75) Inventors: Herbert Hanrieder, Hohenkammer (DE); Alexander Gindorf, Schwabhausen (DE); Joachim Bamberg, Dachau (DE); Gunter Zenzinger, Petershausen (DE)

Correspondence Address: MCANDREWS HELD & MALLOY, LTD, 500 WEST MADISON STREET, SUITE 3400, CHICAGO, IL, 60661, US

(73) Assignee: MTU Aero Engines GmbH, Muchen (DE)

(21) Appl. No.: 12/212,849

(22) Filed: Sep. 18, 2008

(30) Foreign Application Priority Data
Sep. 18, 2007 (DE) DE 102007044516.6

(51) Int. Cl. F01D 5/14; B23K 13/01

(52) U.S. Cl. 416/223 A; 219/617

(57) ABSTRACT

The present technology concerns one or more methods for joining of metal components especially components of a gas turbine, in which joining of the corresponding joining surfaces of the components occurs by means of an inductive low or high-frequency pressure welding and in which, before heating and joining of the components by means of inductive low or high-frequency pressure welding, sputter etching of the joining surfaces is carried out. The present technology also concerns a device for execution of an inductive low or high-frequency pressure welding method for joining the metal components, especially components of a gas turbine, with at least one induction generator and at least one inductor, as well as a component produced with the method according to the present technology.

### RELATED APPLICATIONS

This application claims priority to German Patent Application No. DE 10 2007 044 516.6, filed Sep. 18, 2007, entitled “Verfahren zum Berbinden von metallischen Bauelementen und Vorrichtung zur Durchfuhrung eines induktiven Nieder-oder Hochfrequenzpresschweipverfahrens”. German Application No. DE 10 2007 044 516.6 is hereby incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present technology generally relates to a method for the joining of metal components, especially components of a gas turbine, in which joining of corresponding joining surfaces of the components occurs by means of an inductive low or high-frequency pressure welding. The present technology also concerns a device for execution of an inductive low or high-frequency pressure welding method for joining the metal components, especially components of a gas turbine, with at least one induction generator and at least one inductor. The present technology also relates and involves the one or more components produced with the aforementioned method.

Different methods for joining of metal components by inductive high-frequency welding are known to an extent within the conventional art. For example, DE 198 58 702 A1 describes a method for the joining of blade parts of a gas turbine, in which a blade section and at least one other blade part are prepared. Corresponding joining surfaces of these elements are then positioned flush at a spacing from each other and then welded by excitation of an inductor with high-frequency current and by bringing together of their heated joining surfaces. In this case the inductor is excited with a constant frequency which is generally above 0.75 MHz. The frequency is also chosen as a function of the geometry of the joining surfaces. Additional inductive high-frequency pressure welding methods are known from EP 1 112 141 B1 and EP 1 140 417 B1. In addition to the uniform heating of the two welding partners, it is also important for the quality of the joint that the joining surfaces of the components be as free, preferably free as possible of deposits and especially oxides. The joining surfaces of the components are ordinarily cleaned before welding, but not all oxides are removed. If they remain on the surface, subsequent welding defects can result, especially in titanium alloys. These welding defects develop especially by inclusions of oxides in the weld. In addition, in the known low or high-frequency pressure welding methods, as in other welding methods, a relatively large amount of material must be driven out from the joining zone of the components in order to prevent joining of oxidized component surfaces. Thus, there is a need for an improved method of joining component surfaces and devices to accomplish such methods.

### BRIEF SUMMARY OF THE INVENTION

In one aspect of the present technology there is provided a method for joining of metal components, especially components of a gas turbine that provides reliable, enduring and high-quality joining of the components.

Another aspect of the present technology provides a device for the execution of an inductive low or high-frequency pressure welding method for the joining of metal components, especially components of a gas turbine, which provides reliable, enduring and very high-quality joining of such components.

A still further aspect of the present technology provides one or more components of the type just mentioned based upon the methods and devices above which provides reliable, enduring and very high-quality joining of the individual components with each other.

These aspects and advantages are achieved by the features of the methods, devices and components described and claimed herein.

These aspects are achieved by various advantageous embodiments of the methods, devices and components of the present technology described and claimed herein.

### BRIEF DESCRIPTION OF SEVERAL VIEWS OF THE DRAWINGS

FIG. 1 depicts a schematic view of at least one device for executing an inductive low or high-frequency pressure welding method for joining of metal components in accordance with certain embodiments of the present technology.

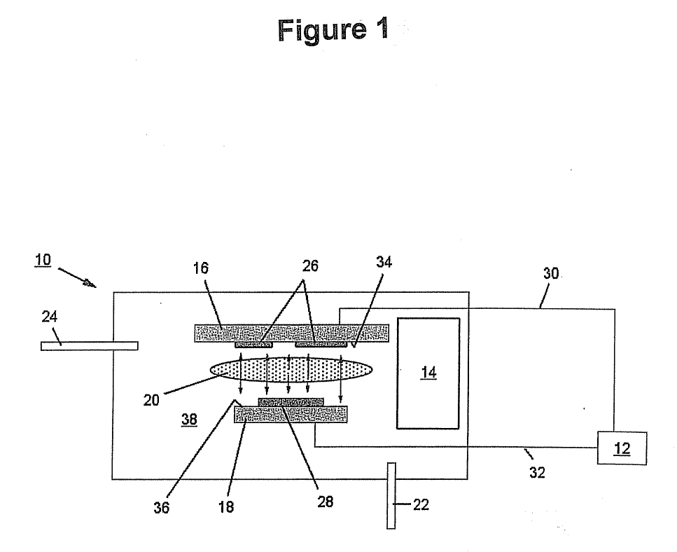

### DETAILED DESCRIPTION OF THE INVENTION

At least one method according to the present technology for joining of metal components, especially components of a gas turbine includes joining of the corresponding joining surfaces of the components by means of an inductive low or high-frequency pressure welding method in which sputter etching of the joining surfaces is conducted before heating and joining of the components by inductive low or high-frequency pressure welding. Undesired deposits and oxides on the metal joining surfaces of the components being joined can be reliably removed by sputter etching. Highly pure metal surfaces can be produced, which can be welded to each other (e.g., immediately welded together) without additional machining steps. Cleaning of the joining surfaces by sputter etching increases the quality of welding significantly, since defects that can develop, for example, by inclusion of oxides in the forming weld, can be reliably prevented. Because of the oxide-free joining of surfaces, excess material longer must be driven out from the joining zone. In other words, the stagnation path can be significantly reduced so that even components having large cross section can be joined. Cleaning by sputter etching is particularly advantageous, since large-surface substrates can be processed with it. Since sputter etching is a purely physical process, the joining surfaces of the components being joined are not chemically altered or influence by sputter etching during cleaning.

Certain embodiments of the method according to the present technology comprises the following steps for performance of sputter etching: a) connection of the components being joined as electrodes to an induction generator and exposure of the components to voltage; b) introduction of at least one inert gas at least in the area between the joining surfaces of the components being joined; c) ignition of the inert gas to form a plasma by means of the applied low or high-frequency field; and d) application of a direct current (DC) field with alternating polarities at least in the area between the joining surfaces of the components being joined. Since the metal components being welded or joined are connected as electrodes to the induction generator, ignition of the inert gas can occur by the low or high-frequency field generated by the induction generator. The additionally applied DC field with alternating polarity and the related deflection of the inert gas atoms ensures that the two components or their joining surfaces are metallically etched up to the atomic level and therefore cleaned. After performance of sputter etching, separation of the components from the induction generator and connection of the induction generator to an induction coil with at least one induction coil can occur so that after sputter etching (for example, immediately after) the joining process can occur with the components connected as electrodes during sputter etching. By integrating sputter etching into the process of inductive low or high-frequency pressure welding, cost-effective procedures that can be implemented relatively easily are obtained during high-quality joining of metal components. In other embodiments of the method according to the present technology the method step b) can be conducted before method step a) and/or method step b) before method step c). Other procedures are also conceivable.

In certain embodiments of the present technology, the inert gas is a noble gas, particularly argon, for example. Use of argon has proven to be particularly advantageous in performance of sputter etching, since, although not wanting to be bound by particular theory, it is believed that relatively high energies can be transferred by the argon atoms to the deposits being eliminated and/or oxides on the joining surfaces being joined.

In certain embodiments of the present technology, ignition of the inert gas according to method step c) occurs at a frequency in the range between about 0.05 and about 2.5 MHz. The frequencies used during inductive low or high-frequency pressure welding are also chosen from a range between about 0.05 and about 2.5 MHz.

In certain embodiments of the present technology, a partial vacuum is produced before and/or during sputtering etching of the joining surfaces in the area between the joining surfaces of the components being joined. This ensures that the ablation products produced by sputter etching are prevented or eliminated from the area of the joining surfaces of the components. A corresponding deposition of these products on the joining surfaces can be reliably prevented.

In certain embodiments of the present technology, the first component is a blade or part of a blade of a rotor in a gas turbine and the second component is a ring or disk of the rotor or a blade foot arranged on the periphery of the ring or disk. However, it is also possible that the components are parts of a blade of a rotor and a gas turbine.

Certain embodiments of the present technology provide a device for execution of inductive low or high-frequency pressure welding for joining of metal components, especially components of a gas turbine, including at least one induction generator and at least one inductor, the device also having means for joining and separation of the components being joined and a means for connection and separation of the components being joined as electrodes to the induction generator. The device also has a gas space to accommodate the components being joined and at least one inert gas as well as at least one DC voltage source to generate a DC voltage field with alternating polarities at least in the area between the joining surfaces of the components being joined. By integration of elements for execution of sputter etching into the device for execution of inductive low or high-frequency pressure welding according to the present technology, residue-free and especially oxide-free metal surfaces can be produced, which can be welded to each other immediately after sputter etching. The device according to the present technology ensures reliable, enduring and very high quality joining of the components being joined. By connection of the components being joined as electrodes to the induction generator it is possible to use the low or high-frequency field generated by the induction generator to ignite the inert gas. The applied DC voltage field with alternating polarities causes bombardment of the joining surfaces of the components with atoms of the inert gas and corresponding ablation of undesired deposits and oxides on the joining surface (sputter etching). The device according to the present technology is relatively simple in design and therefore can be cost-effectively produced. It is also possible with the device according to the present technology to conduct the joining process and the preceding cleaning process of the joining surfaces very quickly so that larger numbers of parts can be processed.

In certain embodiments of the present technology, the device has a connection means for the induction generator with the inductor. The connection means for the induction generator with the inductor can then be integrated with the connection and separation means of the components being joined as electrodes to the induction generator. The device according to the present technology also usually has an introduction means for the inert gas into the gas phase. The device can also have a generation means of a partial vacuum in the gas phase.

In certain embodiments of the present technology, the inert gas is noble gas, particularly argon, for example. Ignition of the inert gas can then occur by means of the at least low or high-frequency field applied in the gas phase at a frequency in the range between about 0.05 and about 2.5 Mhz. The frequencies used during inductive low or high-frequency pressure welding can also be chosen from the range between about 0.05 and about 2.5 MHz.

Certain embodiments of the present technology provide a component of a gas turbine having at least a first and a second component (however, additional components are envisaged), and that is produced according to a method according to the present technology described above. The first component can then be a blade or part of a blade of a rotor in a gas turbine and the second component a ring or a disk of the rotor or a blade foot arranged on the periphery of the ring or disk. However, it is also possible that the components are parts of a blade of a rotor in a gas turbine.

Other advantages, features and details of the present technology are apparent from the following description of a practical example shown in the drawing.

The FIGURE shows a schematic view of a device 10 for execution of an inductive low or high-frequency pressure welding method for joining of metal components 16, 18. The device includes an induction generator 12 for generation of a low or high-frequency field and an inductor (not shown) for subsequent execution of the joining method. The induction generator 12 in the FIGURE is connected to the components 16, 18 being joined as electrodes. The mentioned low or high-frequency field is generated via the components 16, 18, this field being used to ignite an inert gas situated in gas space 38, especially argon, and to form a corresponding plasma 20. The device 10 also includes a dc voltage source 14 to generate a DC voltage field with alternating polarities at least in the area between components 16, 18 and especially between the joining surfaces 34, 36 of components 16, 18 being joined. By means of the DC voltage field with alternating polarities, bombardment of the joining surfaces 34, 36 occurs by the inert gas atoms, in which the deposits and oxides 26, 28 that are situated on the joining surfaces 34, 36 being joined are physically removed from the joining surfaces 34, 36. This process referred to as sputter etching occurs purely physically, in which the deposits and oxides 26, 28 are released by a mechanical pulse transferred by the plasma 20 or inert gas atoms. The ablation products are transported away from it by means 24 for generation of a partial vacuum in gas space 38. The inert gas is introduced to gas space 38 via means 22.

It is also provided that the induction generator 12 may be connected by electrically conducting connections 30, 32 to a component 16, 18. The means for connection and separation of the components 16, 18 being joined as electrodes to the induction generator 12 are not shown. The same applies for the means for connection of the induction generator 12 to the inductor.

The present technology has now been described in such full, clear, concise and exact terms as to enable a person familiar in the art to which it pertains, to practice the same. It is to be understood that the foregoing describes preferred embodiments and examples of the present technology and that modifications may be made therein without departing from the spirit or scope of the present technology as set forth in the claims. Moreover, while particular elements, embodiments and applications of the present technology have been shown and described, it will be understood, of course, that the present technology is not limited thereto since modifications can be made by those familiar in the art without departing from the scope of the present disclosure, particularly in light of the foregoing teachings and appended claims. Moreover, it is also understood that the embodiments shown in the drawings, if any, and as described above are merely for illustrative purposes and not intended to limit the scope of the present technology, which is defined by the following claims as interpreted according to the principles of patent law, including the Doctrine of Equivalents. Further, all references cited herein are incorporated in their entirety.

1. A method for joining two or more metal components, the metal components having at least one joining surface, the method comprising the steps of:
sputter etching the joining surfaces of the metal components; and
heating and joining the components by at least one of inductive low-frequency pressure welding or high-frequency pressure welding,
wherein the sputter etching step occurs before the heating and joining step.

2. The method of claim 1, wherein the metal components are components of a gas turbine.

3. The method of claim 1, wherein the sputter etching step further comprises steps of
connecting the metal components to an induction generator via electrodes and exposing the components to a voltage;
introducing at least one inert gas in at least the area between the joining surfaces of the metal components being joined;
forming a plasma by applying at least one of a low-frequency field or a high-frequency field to ignite the inert gas; and
applying a direct current voltage field with alternating polarities to at least the area between the joining surfaces of the metal components being joined.

4. The method of claim 3, further comprising the steps of:
separating the components from the induction generator; and
connecting the induction generator to at least one induction coil.

5. The method of claim 3 wherein the inert gas is a noble gas.

6. The method of claim 5, wherein the noble gas is argon.

7. The method of claim 3, wherein the application of a low-frequency field or a high frequency field to ignite the inert gas occurs at a frequency in the range between about 0.05 and about 2.5 MHz.

8. The method of claim 1, wherein the frequencies used during inductive low-frequency pressure welding or high-frequency pressure welding are between about 0.05 and about 2.5 MHz.

9. The method of claim 1, further comprising the step of producing a partial vacuum in the area between the joining surfaces of the metal components being joined.

10. The method of claim 2, wherein the first component is at least one of a blade or a part of a blade of a rotor in a gas turbine, and the second component is at least one of a ring of a rotor, a disk of a rotor, or a blade foot arranged on the periphery of at least one of a ring of a rotor or a disk of a rotor.

11. The method of claim 2, wherein the metal components are parts of a blade or a rotor in a gas turbine.

12. A device for joining metal components using inductive low-frequency or high-frequency pressure welding, the device comprising:
at least one induction generator;
at least one inductor;
an attachment means to connect and separate the metal components being joined to an induction generator as electrodes;
at least one gas space to accommodate the metal components being joined;
at least one inert gas; and
at least one direct current voltage source to generate a direct current voltage field with alternating polarities in at least the area between the joining surfaces of the metal components being joined.

13. The device of claim 12, wherein the metal components being joined are metal components of a gas turbine.

14. The device of claim 12, further comprising a connection means to connect the induction generator to the inductor.

15. The device of claim 12, further comprising an introduction means to introduce the inert gas into the gas space.

16. The device of claim 12, further comprising a generation means to generate a partial vacuum in gas space.

17. The device of claim 12, wherein the inert gas is at least one noble gas.

18. The device of claim 17, wherein the noble gas is argon.

19. The device of claim 12, further comprising a means for applying a low-frequency or high-frequency field in the gas space to igniting the inert gas.

20. The device of claim 19, wherein the frequency applied by the means for igniting the inert gas is in a range between about 0.05 and about 2.5 MHz.

21. The device of claim 12, wherein the frequencies applied by the device during inductive low-frequency or high-frequency pressure welding are in a range between about 0.05 and about 2.5 MHz.

22. A component of a gas turbine comprising at least one first component and at least one second component, wherein the first component and the second component produced according to the method of claim 1.

23. The component of claim 22, wherein the first component is at least one of a blade or a part of a blade of a rotor in a gas turbine, and the second component is at least one of a ring of a rotor, a disk of a rotor, or a blade foot arranged on the periphery of a ring or disk of a rotor.

24. The component of claim 22, wherein the first component and the second component are both parts of a blade of a rotor in a gas turbine.
